(19) United States
(12) Patent Application Publication
(10) Pub. No.: US 2001/0037662 A1
(43) Pub. Date: Nov. 8, 2001

(54) Method for maintaining quality of optical fiber preform and storage apparatus of the same

(75) Inventors: Yukio Kohmura, Aichi (JP); Yasuhiro Naka, Mie (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric CO., LTD, Chiyoda-ku (JP)

(21) Appl. No.: 09/768,055

(22) Filed: Jan. 24, 2001

Related U.S. Application Data
(63) Continuation of application No. PCT/JP00/03309, filed on May 24, 2000.

(30) Foreign Application Priority Data
May 24, 1999 (JP) 11-143125

(51) Int. Cl. C03B 37/00

(52) U.S. Cl. 65/325; 65/503; 65/524; 134/1; 134/2

(57) ABSTRACT

The present invention improves a tensile strength of an optical fiber obtained by heating to melt and drawing a preform and thereby realizes an extension of the surviving length of an optical fiber in a screening test. For this purpose, an optical fiber preform before the drawing step, that is, a preform (51), is stored while exposed to an ionized gas, that is, air (G), in a storage apparatus, and this stored preform (51) is conveyed while exposed to the ionized air (G) in the process of conveying this to a drawing use heating furnace, whereby deposition of foreign substances to the preform (51) is suppressed and a reduction of the tensile strength of the optical fiber due to the foreign substances can be prevented.

### TECHNICAL FIELD

The present invention relates to a method for maintaining the quality of an optical fiber preform suitable for suppressing deposition of dust and other undesirable substances on the optical fiber preform until the optical fiber preform is heated to melt and is drawn, and a storage apparatus of an optical fiber preform suitable for storing an optical fiber preform before a drawing process.

### BACKGROUND ART

An optical fiber is produced by synthesizing a porous optical fiber glass preform made of a core and a cladding by for example a VAD (vapor-phase axial deposition) process, then dehydrating and vitrifying the same and, if necessary, stretching it to an outer diameter suitable for drawing to produce an optical fiber preform, then heating it to melt in a drawing heating furnace and drawing from the end of the preform. The single mode optical fiber manufactured in this way is constituted by for example a core having an outer diameter of 10 μm and a cladding having an outer diameter of 125 μm provided on the periphery of the core.

A tensile strength of the produced optical fiber of, for example, 5 kgf or more is required. For this reason, an optical fiber having a low tensile strength of 1 kgf or less breaks in a screening test process carried out after the drawing for the optical fiber.

Accordingly, when the frequency of breakage of the optical fiber in the screening test process is high, the length (nonbreakage length) of the optical fiber obtained after the screening test becomes short.

As the cause of shortening of the nonbreakage length of the optical fiber, that is, the cause of the manufacture of an optical fiber having a lowered tensile strength, for example, undesirable substances existing inside the optical fiber, undesirable substances deposited to the surface of the optical fiber, defects in coating of the resin, etc. can be considered, but particularly undesirable substances deposited on the surface of the optical fiber is the main cause in many cases.

The preform before the drawing is a high purity silica-glass, so has a very high electric insulation property. The preform is usually stored in a clean room, but there may be dust even in a clean room. Static electricity is generated at the surface of the preform due to the contact of dust on the preform. The dust contacted to the preform remains to deposit on the preform by the static electricity. The amount of deposited the dust on the preform becomes larger as the storage time in the clean room becomes longer.

The preform with the dust deposited thereon is carried to the drawing heating furnace in a state with the dust deposited on it, heated to melt at a high temperature, and consequently drawn to produce the optical fiber.

For this reason, the undesirable substances easily deposit on the surface of the drawn optical fiber, or crystalized silica-glass having these undesirable substances is easily formed in the drawn optical fiber. These undesirable substances may be nucleuses (or seeds) for crystallization of the glass and such the crystalized silica-glass become the cause of the breakage of the optical fiber at the time of a screening test.

A method and apparatus for solving this problem is disclosed in Japanese Unexamined Patent Publication (Kokai) No. 60-215543 in which a stream of ions is blown to the surface of the preform immediately before the drawing in the drawing process of the preform. In the apparatus disclosed in Japanese Unexamined Patent Publication (Kokai) No. 60-215543, a gas inlet pipe is provided in a heating furnace and the stream of ions is blown to an upper portion of the preform suspended by a support, through this gas inlet pipe.

In this method and apparatus, however, when the preform is stored for a long time in an environment where undesirable substances are deposited on the preform after the manufacture of the preform, the expected effects to eliminate the deposition of the undesirable substances cannot be obtained. Namely, there is the disadvantage that after introducing the preform in the state with undesirable substances deposited on it into the heating furnace, the undesirable substances are not sufficiently removed even if the stream of ions is blown on the surface of the preform.

Further, an inert gas such as argon gas is introduced into the heating furnace from a bottom portion toward a top portion of the heating furnace, therefore there is the apprehension that the undesirable substances removed by the stream of ions will float in the heating furnace and be deposited to the preform again.

Further, there are also the disadvantages that the structure of the heating furnace is relatively complex, the provision of the gas inlet pipe for producing the stream of ions in this heating furnace causes a lot of restriction on the structure, and also the equipment costs rise.

### DISCLOSURE OF THE INVENTION

An object of the present invention is to provide a method for maintaining the quality of an optical fiber preform capable of suppressing occurrence of breakage of the optical fiber at the time of a screening test after drawing due to undesirable substances deposited on the surface of the optical fiber preform and capable of extending the nonbreakage length of the optical fiber.

Further, another object of the present invention is to provide a storage apparatus of an optical fiber preform capable of suppressing occurrence of breakage of an optical fiber at the time of a screening test after drawing due to undesirable substances deposited on the surface of the optical fiber preform and capable of extending the nonbreakage length of the optical fiber.

According to a first aspect of the present invention, there is provided a method for maintaining the quality of an optical fiber preform, comprising a step of holding the optical fiber preform in an ionized gas after forming the optical fiber preform and before introducing the optical fiber preform into a heating and drawing furnace.

In the first aspect of the invention, preferably clean air is ionized and blown to the optical fiber preform.

More preferably, an ionized air contained substantially equal amounts of positive and negative polarity of ions are blown to the optical fiber preform.

More preferably, the ionized clean air is blown from a top portion toward a bottom portion of the optical fiber preform suspended by a preform support.

It is also possible to blow the ionized clean air while rotating the optical fiber preform.

It is also possible to mix an inert gas into the clean air.

In the first aspect of the invention, it is also possible to hold the optical fiber preform between two discharge electrodes of an ion generator having two discharge electrodes.

In the first aspect of the invention, preferably an ionized air contained substantially equal amounts of positive and negative polarity of ions are generated between the discharge electrodes.

Preferably, the process of holding the optical fiber preform in the ionized gas comprises a storing step of storing the optical fiber preform at a predetermined storage room, and a conveyance process of conveying the optical fiber preform from the storage room to the heating and drawing furnace.

In the conveyance step, an ion generator having two discharge electrodes is arranged in a conveyance path of the optical fiber preform to the heating furnace and the optical fiber preform is passed between the two discharge electrodes.

According to a second aspect of the present invention, there is provided a storage apparatus of an optical fiber preform for storing an optical fiber preform before introduction into a heating and drawing furnace for drawing an optical fiber, comprising holding chamber for holding the optical fiber preform inside it and an ionized gas feeding means being provided in the holding chamber and feeding the ionized gas to the optical fiber preform.

In the second aspect of the present invention, the ionized gas feeding means ionizes the clean air and blows the same to the optical fiber preform.

Preferably, the ionized gas feeding means blows an ionized air contained substantially equal amounts of positive and negative polarity of ions to the optical fiber preform.

In the second aspect of the invention, the ionized gas feeding means comprises an ion generator having two discharge electrodes sandwiching the optical fiber preform therebetween.

Preferably, the ion generator ionizes air between the two discharge electrode to substantially equal amounts of positive and negative ions.

In the first and second aspects of the present invention, by holding the optical fiber preform in the ionized gas, the surface of the optical fiber preform is electrically neutralized. When an object contacts the surface of the insulating optical fiber preform, charges are exchanged at the surface of the insulator, therefore the surface is charged to either the positive or negative states. The charge does not easily move at the insulator due to the electric resistance, therefore the charged state continues, dust is apt to be attracted by the static electricity, and dust or other undesirable substances easily deposit on the surface of the optical fiber preform. If the surface of the optical fiber preform is in an electrically neutralized state, the deposition of dust or other undesirable substances on the optical fiber preform can be suppressed.

In this way, by creating a state where dust or other undesirable substances do not deposit on the preform before introduction into the drawing heating furnace as much as possible and drawing this preform in the drawing heating furnace to produce an optical fiber, the frequency of breakage of the optical fiber due to undesirable substances in the screening test after the drawing of the produced optical fiber can be suppressed.

### BRIEF DESCRIPTION OF THE DRAWINGS

FIG. 1 is a view of the configuration of a storage apparatus of an optical fiber preform according to an embodiment of the present invention.

FIG. 2 is a view of the configuration of an embodiment of a storage apparatus of an optical fiber preform.

FIG. 3 is a view of the configuration of still another embodiment of a storage apparatus of an optical fiber preform.

FIG. 4 is a view for explaining an embodiment of a method for maintaining the quality of an optical fiber preform according to the present invention.

FIG. 5 is a view for explaining another embodiment of the method for maintaining the quality of an optical fiber preform according to the present invention.

FIG. 6 is a flow chart of an example of the process of production of an optical fiber.

### BEST MODE FOR CARRYING OUT THE INVENTION

Preferred embodiments of the present invention will be explained next by referring to the attached drawings.

First Embodiment

Below, an explanation will be made of an embodiment of a storage apparatus of an optical fiber preform according to the present invention.

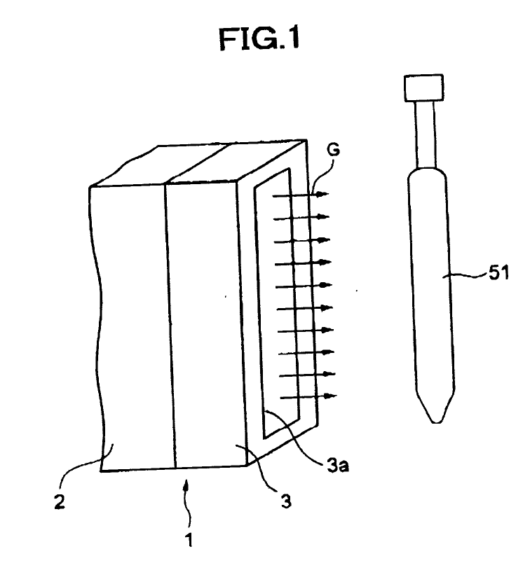

FIG. 1 is a view of the configuration of a storage apparatus of an optical fiber preform according to an embodiment of the present invention.

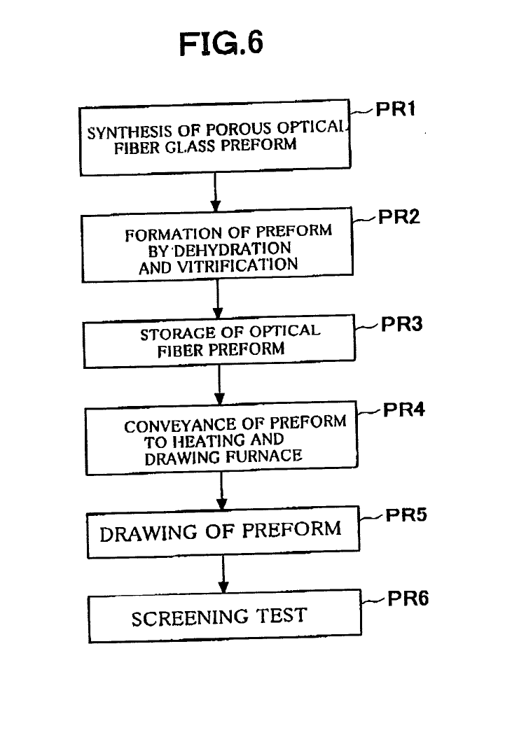

Here, before explaining the concrete configuration of the storage apparatus, an explanation will be made of an example of the process of production of an optical fiber by referring to the flow chart of FIG. 6.

As shown in FIG. 6, first, a porous optical fiber glass preform formed of a core and a cladding is synthesized by for example the VAD (vapor-phase axial deposition) process (process PR1) Then, this porous optical fiber glass preform is dehydrated and vitrified, then is stretched to an outer diameter suitable for drawing according to need to produce a preform (process PR2).

Then, this preform is stored at a predetermined location (process PR3). This preform is stored for example for several hours to a couple of days in many cases.

Then, the preform stored in the storage apparatus is conveyed to the drawing heating furnace (process PR4). Note that, as this storage apparatus, use is made of a storage apparatus of an optical fiber preform according to the present embodiment.

Then, this preform is heated to melt in a drawing heating furnace and drawn from the end of the preform so as to produce the optical fiber (process PR5). A coating of resin is made on the drawn optical fiber, then the optical fiber is taken up on a bobbin.

Then, the produced optical fiber is subjected to a screening test (process PR6). This screening test selects optical fibers satisfying the required tensile strength.

In FIG. 1, the storage apparatus of an optical fiber preform according to the present embodiment has an ionized gas feeder 1 provided in a clean room serving as the holding chamber of the present intention. A preform 51 is stored in the clean room.

This preform 51 is held in the clean room immediately after the dehydration and vitrification of the porous optical fiber glass preform explained in FIG. 6. Specially, the preform 51 is suspended at the top end by a not illustrated support in the clean room. By holding the preform in the clean room immediately after the dehydration and vitrification, the charging of the surface of the preform 51 is prevented, and the deposition of dust and other undesirable substances can be prevented before occurrence.

The ionized gas feeder 1 has a clean air blower 2 for feeding the cleaned air and an ion generator 3 for ionizing the air fed from the clean air blower 2 by alternately charging the air to positive and negative. Note that the configuration of the ion generator 3 is well known, so a detailed explanation will be omitted.

The clean air blower 2 feeds the cleaned air to the ion generator 3 in a predetermined amount and flow rate.

The clean air blower 2 has a fan and an air-filter. The fan feeds an air to the air-filter in a predetermined amount and flow rate. As the air-filter, for example, an ultra low penetration filter can be used. The ultra low penetration filter cannot path particles having a diameter of 0.15 μm at the rate of 99.9995% under a rating flow rate. Therefore, the clean air does not contain undesired and adversary affective particles having diameter over 0.15 μm.

The ion generator 3 has for example discharge electrodes for ionizing the air to positive and negative polarity inside it and ionizes substantially the same amounts of the air to the positive and negative state by applying a high voltage to these discharge electrodes.

Air G ionized in the ion generator 3 is blown from a blowing port 3a of the ion generator 3 formed facing the preform 51.

At this time, substantially the same amounts of air G ionized to the positive and negative states are constantly blown to the preform 51 stored in the clean room.

Accordingly, the surface of the preform 51 is electrically neutralized by the ionized air G, and the potential of the surface of the preform 51 becomes substantially zero.

Further, since substantially the same amounts of air G ionized to the positive and negative states are blown, even in a case where the preform 51 is charged either positive or negative, it is electrically neutralized.

In addition to this, according to the present embodiment, since air is blown on the surface of the preform 51, the dust deposited on the surface of the preform 51 can be positively eliminated.

In this way, the surface of the preform 51 stored in the storage apparatus (clean room) of the optical fiber preform is kept in a state where there is almost no deposition of undesirable substances.

By introducing the preform 51 in this state into the drawing heating furnace and heating it to melt and drawing from the end of the preform 51 to produce the optical fiber, it becomes possible to suppress the occurrence of defects in the optical fiber due to undesirable substances deposited on the surface of the preform 51 as much as possible.

As a result, in a screening test where a load is applied to the produced optical fiber, the breakage of the optical fiber can be prevented, and it becomes possible to greatly extend the nonbreakage length of the optical fiber.

Further, in the present embodiment, since the ionized air G is constantly fed into the clean room containing the preform 51, dust and other undesirable substances become hard to charge and the cleanness in the clean room can be improved.

### EXAMPLE

A preform 51 having for example an outer diameter of 80 mm and a length of 1 m was stored in the storage apparatus of an optical fiber preform having the above configuration, then was drawn in a heating furnace to produce an optical fiber.

Note that the amount of air of the ion generator 3 in the storage apparatus was set at about 1000 SIM, and the flow rate was set at about 0.5 to 5 m/min.

The nonbreakage length of the produced optical fiber became 800 km or more.

Conventionally, the nonbreakage length of the optical fiber was about 100 km at the maximum, so the nonbreakage length could be greatly extended.

Note that, in the above embodiment, the ionized gas feeder 1 ionized the cleaned air, but the present invention is not limited to this.

For example, by mixing an easily ionizable inert gas such as nitrogen and argon into the cleaned air, the ionization becomes further easier.

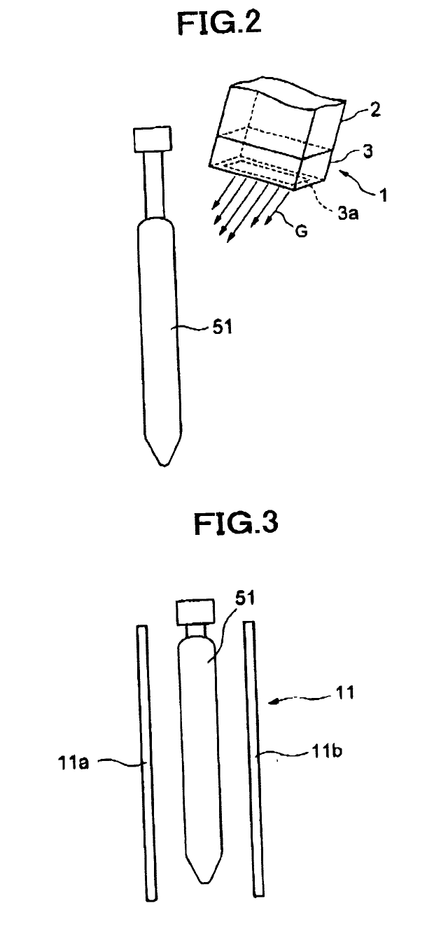

Note that, for example, as shown in FIG. 2, a configuration providing the ionized gas feeder 1 above the preform 51 and blowing the air downward with respect to the preform 51 can also be employed. By employing such a configuration, the potential of the surface of the preform 51 can be neutralized with a high efficiency by a small sized ionized gas feeder 1 and the attraction of dust can be prevented.

Further, it is also possible to rotate the preform 51 about its longitudinal direction. By employing such a configuration, it becomes possible to uniformly blow the ionized air G to the entire surface of the preform 51 and neutralize the potential of the surface of the preform 51 further efficiently and as a result prevent the attraction of dust.

Second Embodiment

Another embodiment of the storage apparatus of an optical fiber preform according to the present invention will be explained by referring to FIG. 3.

FIG. 3 is a view of the configuration of another embodiment of the storage apparatus of an optical fiber preform.

The storage apparatus of the optical fiber preform shown in FIG. 3 has an ion generator 11 provided with two discharge plates 11a and 11b provided in parallel spaced apart from each other in a not illustrated clean room.

The optical fiber preform is stored in a state with the preform 51 inserted between the two discharge plates 11a and 11b. The preform 51 is suspended at the top end by a not illustrated support.

The discharge plates 11a and 11b ionize the air at the periphery of the discharge plates 11a and 11b to the positive and negative states when applied with a high voltage.

Substantially the same amounts of air ionized to the positive and negative states are present between the discharge plates 11a and 11b.

For this reason, the preform 51 inserted between the discharge plates 11a and 11b is constantly exposed to the ionized air, therefore the surface of the preform 51 is always electrically neutralized, the surface of the preform 51 becomes zero potential, and the deposition of undesirable substances to the surface of the preform 51 can be suppressed.

As described above, according to the storage apparatus of the optical fiber preform of the present embodiment, since the ion generator 11 provided with two discharge plates 11a and 11b is provided in the clean room, the deposition of undesirable substances to the surface of the preform 51 can be suppressed by a relatively simple apparatus. Further, the charging of the surface of the preform 51 can be prevented without blowing air, therefore the configuration of the ion generator 11 can be simplified. By employing such a configuration, a blower becomes unnecessary. For example, when conveying the storage apparatus, the storage apparatus can be easily conveyed.

Note that, in the present embodiment, a configuration arranging the discharge plates 11a and 11b in parallel was employed, but it is also possible to employ a configuration making the discharge plates 11a and 11b curved to surround the periphery of the preform 51. By shaping the discharge plates 11a and 11b in this way, the dust entering from the outside of the discharge plates 11a and 11b becomes further harder to deposit on the preform 51 surrounded by the discharge plates 11a and 11b.

Third Embodiment

Below, an explanation will be made of an embodiment of a method for maintaining the quality of the optical fiber preform according to the present invention.

FIG. 4 is a view for explaining an embodiment of the method of maintaining the quality of the optical fiber preform according to the present invention.

In the first and second embodiments, the explanation was made of the method of storing an optical fiber preform before drawing the preform 51 by using a storage apparatus. In the present embodiment, an explanation will be made of the method of conveying the preform 51 from the storage apparatus to the heating furnace for the drawing.

As shown in FIG. 4, an ion generator 21 provided with two discharge plates 21a and 21b is provided in part or all of the conveyance path between the storage apparatus and the heating furnace for the drawing.

The discharge plates 21a and 21b ionize the air at the periphery of the discharge plates 21a and 21b to the positive and negative states when applied with a high voltage, so substantially the same amounts of air ionized to the positive and negative state are present between the discharge plates 21a and 21b.

When conveying the preform 51 in the conveyance direction indicated by an arrow in the state with ionized air between the discharge plates 21a and 21b, the preform 51 is passed between two discharge plates 21a and 21b in this way.

Since the preform 51 is exposed to the ionized air, the surface of the preform 51 exhibits an electrically neutralized state even during the conveyance, and the deposition of undesirable substances can be prevented.

According to the present embodiment, by carrying the preform in a state exposed to the ionized air G in the storage apparatus and in a state where dust and other undesirable substances do not deposit much at all into the heating furnace while exposing the preform to the ionized air G even during conveyance, deposition of undesirable substances to the surface of the preform 51 during conveyance can be suppressed, so a state where undesirable substances are prevented from being deposited to the preform 51 carried into the heating furnace as much as possible can be exhibited.

Note that, in the present embodiment, a configuration providing the discharge plates 21a and 21b along the conveyance path from the storage apparatus to the heating furnace and passing the preform 51 between these discharge plates 21a and 21b was employed, but a configuration conveying both of the preform 51 and the discharge plates 21a and 21b in the state with the preform 51 arranged between the discharge plates 21a and 21b can be employed.

Further, the state where the preform 51 is exposed to the ionized air also in the storage apparatus as in the present embodiment is more preferred from the viewpoint of suppressing the deposition of dust, but it is also possible to create a state where the preform 51 is exposed to the ionized air only during the conveyance.

Fourth Embodiment

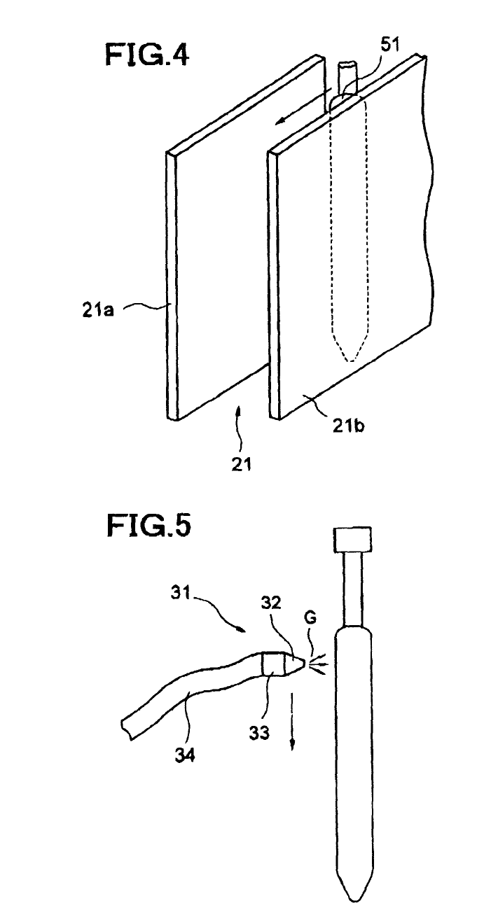

FIG. 5 is a view for explaining another embodiment of the method for maintaining the quality of an optical fiber preform according to the present invention.

In the third embodiment, the configuration of passing the conveyed preform 51 between the discharge plates 21a and 21b was employed, but in the present embodiment, in order to remove the undesirable substances deposited on the preform 51 during the conveyance, a configuration of directly blowing the ionized air G to the surface of the preform 51 by an ionized gas blower 31 is employed.

The ionized gas blower 31 has a clean air feed duct 34 for feeding the cleaned air, a discharge portion 33 connected to an outlet portion of the clean air feed duct 34 and having discharge electrodes, and a nozzle portion 32 connected to the discharge portion 33 and communicated with the clean air feed duct 34 through the discharge portion 33.

The ionized air G is blown from the nozzle portion 32 toward the preform 51.

Further, by moving the ionized gas blower 31 with respect to the preform 51, the ionized air G can be blown to the entire preform 51.

By employing such a configuration, the charging of the preform 51 can be prevented and, at the same time, dust and other undesirable substances can be blown away since the air is blown, thus the dust deposited on the preform 51 can be reliably removed.

### EXAMPLE

A preform 51 having for example an outer diameter of 130 mm and a length of about 2 m was stored in the storage apparatus of the optical fiber preform of the above configuration, then the ionized air G was blown by the ionized gas blower 31 before the drawing, then drawn.

As the conditions of the ionized gas blower 31, the amount of the cleaned air from the clean air feed duct 34 was set to 30 to 100 SLM, the pressure was set to 0.05 to 0.7 MPa, the nozzle diameter of the nozzle portion 32 was set to about 2 to 3 mm, and the input current to the discharge electrodes provided in the discharge portion 33 was set to about 300 mA.

As a result, the nonbreakage length of the produced optical fiber became about 1000 km, so the nonbreakage length of the optical fiber could be greatly extended in comparison with the related art.

Industrial Applicability

As described above, the storage apparatus of the optical fiber preform according to the present invention can suppress the deposition of undesirable substances on the preform before the drawing of the optical fiber and, as a result, it becomes possible to improve the tensile strength of the optical fiber after the drawing and rapidly extend the nonbreakage length, therefore the apparatus is suitable for use in the process of production of an optical fiber.

The method for maintaining the quality of the optical fiber preform according to the present invention is useful for improving the tensile strength of the optical fiber after drawing and rapidly extending the nonbreakage length, so is suitable for use in adapted when used in the process of production of an optical fiber.

1. A method for maintaining the quality of an optical fiber preform, comprising a step of holding said optical fiber preform in an ionized gas after forming the optical fiber preform and before introducing the optical fiber preform into a heating and drawing furnace for drawing an optical fiber.

2. A method for maintaining the quality of an optical fiber preform as set forth in claim 1, comprising a step of ionizing clean air and blowing it to said optical fiber preform.

3. A method for maintaining the quality of an optical fiber preform as set forth in claim 2, comprising a step of blowing an ionized air contained substantially equal amounts of positive and negative polarities of ions to said optical fiber preform.

4. A method for maintaining the quality of an optical fiber preform as set forth in claim 3, comprising a step of blowing the ionized clean air from a top portion toward a bottom portion of said optical fiber preform suspended by a preform support.

5. A method for maintaining the quality of an optical fiber preform as set forth in claim 4, comprising a step of blowing the ionized clean air while rotating said optical fiber preform.

6. A method for maintaining the quality of an optical fiber preform as set forth in claim 2, comprising a step of mixing an inert gas into said clean air.

7. A method for maintaining the quality of an optical fiber preform as set forth in claim 1, comprising a step of holding said optical fiber preform between two discharge electrodes of an ion generator having two discharge electrodes.

8. A method for maintaining the quality of an optical fiber preform as set forth in claim 7, comprising a step of generating an ionized air contained substantially equal amounts of positive and negative polarity of ions between said discharge electrodes.

9. A method for maintaining the quality of an optical fiber performs set forth in claim 1, wherein the process of holding said optical fiber preform in the ionized gas comprises a storing step of storing said optical fiber preform at a predetermined storage room, and a conveyance process of conveying said optical fiber preform from said storage room to said heating and drawing furnace.

10. A method for maintaining the quality of an optical fiber preform as set forth in claim 9, wherein in said conveyance step comprises a step of arranging an ion generator having two discharge electrodes in a conveyance path of said optical fiber preform to said heating furnace and passing said optical fiber preform between said two discharge electrodes.

11. A storage apparatus of an optical fiber preform for storing an optical fiber preform before introducing into a heating and drawing furnace for drawing an optical fiber, said apparatus comprising:
a holding chamber for containing said optical fiber preform inside it, and
an ionized gas feeding means provided in said holding chamber and feeding the ionized gas to said optical fiber preform.

12. A storage apparatus of an optical fiber preform as set forth in claim 11, wherein said ionized gas feeding means ionizes the clean air and blows the same to said optical fiber preform.

13. A storage apparatus of an optical fiber preform as set forth in claim 11, wherein said ionized gas feeding means blows an ionized air contained substantially equal amounts of positive and negative polarity of ions to said optical fiber preform.

14. A storage apparatus of an optical fiber preform as set forth in claim 11, wherein said ionized gas feeding means comprises an ion generator having two discharge electrodes sandwiching said optical fiber preform therebetween.

15. A storage apparatus of an optical fiber preform as set forth in claim 14, wherein said ion generator ionizes air between said two discharge electrode to substantially equal amounts of positive and negative ions.
